(19) United States
(12) Patent Application Publication
(10) Pub. No.: US 2015/0235286 A1
(43) Pub. Date: Aug. 20, 2015

(54) On-Line System and Method for Leveraging Purchasing Power

(71) Applicant: SINGKIN HOLDINGS, LLC, Hollywood, FL (US)

(72) Inventor: Keith L. Lampert, Hollywood, FL (US)

(73) Assignee: SINGKIN HOLDINGS, LLC, Hollywood, FL (US)

(21) Appl. No.: 14/180,867

(22) Filed: Feb. 14, 2014

(51) Int. Cl. G06Q 30/06; G06Q 30/02

(52) U.S. Cl. CPC G06Q 30/0605; G06Q 30/0269

(57) ABSTRACT

There is disclosed a system and method that employs internet based crowd sourcing to establish price points and purchase criteria for items that a purchaser community wishes to purchase. A supplier community is provided with an opportunity to sell the item(s) to the purchaser community at the terms offered by the purchaser community, or to counter-offer with terms that the purchaser community may accept or reject.

### TECHNICAL FIELD

The present invention pertains generally to on-line purchasing. More particularly, the invention pertains to a system and method that employs so-called internet based “crowd-sourcing” to identify one or more items that a group of potential consumers may wish to purchase, and employs the mass purchasing power of the group to obtain favorable terms for purchasing the items.

### BACKGROUND

Various manners of purchasing items on-line are known. In the most common scenario, a user employs a vendor website (e.g., macy's.com) or an intermediary website (e.g., amazon.com) to locate and purchase items. In another scenario, the user locates an item of interest and engages in an on-line auction to bid for purchase of the item (e.g., ebay.com). In yet another scenario, the user engages in a so-called “reverse auction” to purchase the item (e.g., priceline.com). Other scenarios are known as well.

While relatively new, the concept of “crowd-sourcing” is now well known, and, generally, refers to on-line methodologies for bringing individuals together and allowing them to collaborate to achieve a goal. Thus, crowd-sourcing employs the power of the group. None of the known options for on-line purchasing, however, presently employs crowd sourcing to negotiate for and/or obtain favorable purchase terms for an item that a group of individuals may wish to purchase.

### SUMMARY

When a group of individuals interested in purchasing the same item congregate to negotiate the purchase of the item, the group has greater purchasing power than each individual purchaser would have alone, including the ability to drive price points. Likewise, when a group of purchasers agree to buy multiple ones of the same item, merchants may benefit because they are able to consummate a substantial sale. The present invention takes advantage of these concepts.

There is provided an on-line, web-based, system and method whereby a user, such as a potential purchaser, joins with others, so as to form a purchaser community. The members of the purchaser community collaboratively and collectively agree to a price or price range at which they would be willing to purchase an item, and they each commit to purchase the item upon specific terms, such as the price, for example via a web site or via messaging. The members of the purchaser community also agree to be bound by any revised terms that the purchaser community may subsequently agree to for purchase of the item, as described below. The terms upon which the members agree to be bound to purchase the item define a “purchase commitment.”

An item to be made available for consideration by the purchaser community may be identified by a server application that tracks social indicators or sentiment within the purchaser community, or that tracks activity in third party social networks (e.g., Facebook.com), to determine a high demand or high trending item(s). Alternatively, high demand or high trending items may be identified by other means such as by research or surveys carried out by a party (including but not limited to the hosting entity), the results of which are supplied to the server. The server application may then present the item to the purchaser community to gauge the purchaser community's interest in purchasing the item and to obtain an indication of the amount that members of the purchaser community would be willing to pay to purchase the item (“interest session”). If the server application determines, after the conclusion of the interest session, that there is sufficient purchase interest in the item by the members of the purchaser community, the server application determines an initial proposed purchase price for the item and other proposed purchase terms and conditions from the data gathered during the interest session (“initial terms”). Thereafter, another session is commenced during which members of the purchaser community commit to purchase the item at the initial terms (“demand gathering session”). During the demand gathering session, members of the purchaser community commit to purchase the item (i.e., make the purchase commitment), for example, by providing credit card information. At the conclusion of the demand gathering session, the server application is thus equipped with the total volume of the item that the members have collectively agreed to purchase (“volume purchase data”) and the initial terms.

The server application publishes the volume purchase data and initial terms as a purchase offer to an on-line supplier community, and suppliers in the on-line supplier community are given an opportunity to accept the purchase offer, or to provide a counter-offer. In the event that no supplier agrees to accept the purchase offer, then any counter offers received from the supplier community that are the closest to the purchase offer are presented to the purchaser community for a vote. If a predetermined number of members agree to accept one of the counter offers (e.g., a super-majority, such as 60%), then the deal is consummated and the members of the purchaser community are each obligated to purchase the item at the agreed upon counter offer terms. If the purchaser community rejects the closest counter offers, then the purchaser community may be given the option to vote to purchase the item from the supplier that provided the next best counter offer. Absent any agreement by the purchaser community, the purchase offer is retracted and the purchaser community members are relieved of their purchase obligations.

In one embodiment, the supplier that has accepted a purchase offer or whose counter offer has been accepted (“accepting supplier”) directly receives payments from each purchaser community member and directly fulfills the orders by shipping the item to each purchaser community member. The accepting supplier preferably also handles all logistics, returns, chargebacks, etc., directly with each member. In another embodiment, the server application, or another server, or the hosting entity itself, acts as an intermediary or clearing house for transactions between the purchaser member community and the accepting supplier.

The operator of the server application and/or hosting entity may generate revenue by way of a monthly member subscription fee, by applying transaction fees, payable by each member, to each purchase, by applying an across the board transaction fee to the entire purchaser community that is divided up among the members, by charging the suppliers of the items a fee or percentage of the sales price, and the like.

### BRIEF DESCRIPTION OF THE DRAWINGS

FIG. 1 illustrates a hardware and network overview of an exemplary system for carrying out the methods disclosed herein, including a server that hosts the server application, according to an embodiment of the invention.

FIGS. 2A and 2B illustrate an exemplary method by which the server application, purchaser community members and the supplier community may cooperate to create and fulfill orders resulting from purchase commitments, according to an embodiment of the invention.

FIG. 3 illustrates an exemplary method by which an accepting supplier(s) may fulfill orders to the purchaser community, according to an embodiment of the invention.

FIG. 4 illustrates an exemplary method by which the server application may identify items to be offered to the purchaser community for a demand gathering session, according to an embodiment of the invention.

FIG. 5 illustrates an exemplary method by which the operator of the server application may generate and collect revenue, according to an embodiment of the invention.

### DETAILED DESCRIPTION OF ILLUSTRATIVE EMBODIMENTS

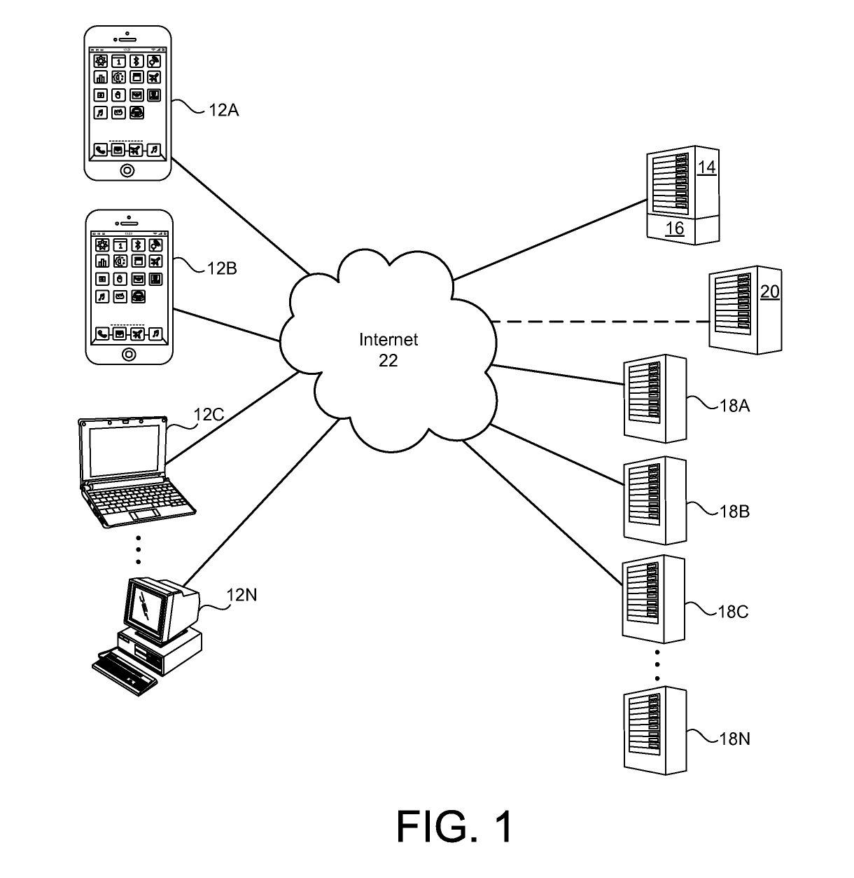

Referring to the drawings, wherein like numerals represent like elements, there is illustrated in FIG. 1 a network environment 10 comprising internet enabled client devices 12a-12n that may communicate, via the internet 22, with a server 14 running a server application 16. The devices 12a-12n may be mobile devices, PC's, laptops and the like. Users of the devices 12a-12n are, typically, shoppers/potential purchasers of items and define a purchaser community 12. There is also illustrated a number of servers 18a-18n operated by various suppliers (e.g., on-line merchants) of items that may be available for on-line purchasing. Examples of operators of servers 18a-18n include macys.com, amazon.com, newegg.com, sears.com, priceline.com, apple.com, just to name a few. The operators of the servers 18a-18n define a supplier community 18. In one embodiment of the invention, one of the servers may be ebay.com, whereupon an offer to make a volume purchase of an item may be placed as a bid on ebay.com, in the manner set forth below.

Also shown in FIG. 1 is a server 20 that may be employed in connection with the payment and fulfillment process of an item that the purchaser community has committed to purchase, as described below. Though FIG. 1 illustrates a server 20, separate from the hosting server 14, for the payment and fulfillment process, it should be understood that the hosting server 14 may carry out the payment and/or fulfillment processes.

The devices 12a-12n may communicate with the server application 16 by way of a website hosted by server 14, and/or by way client based apps (e.g., a Windows 8, Google or Apple app). In addition, or alternatively, the server application and the devices 12a-12n may communicate by way of messaging, including for example, e-mail and/or text messaging.

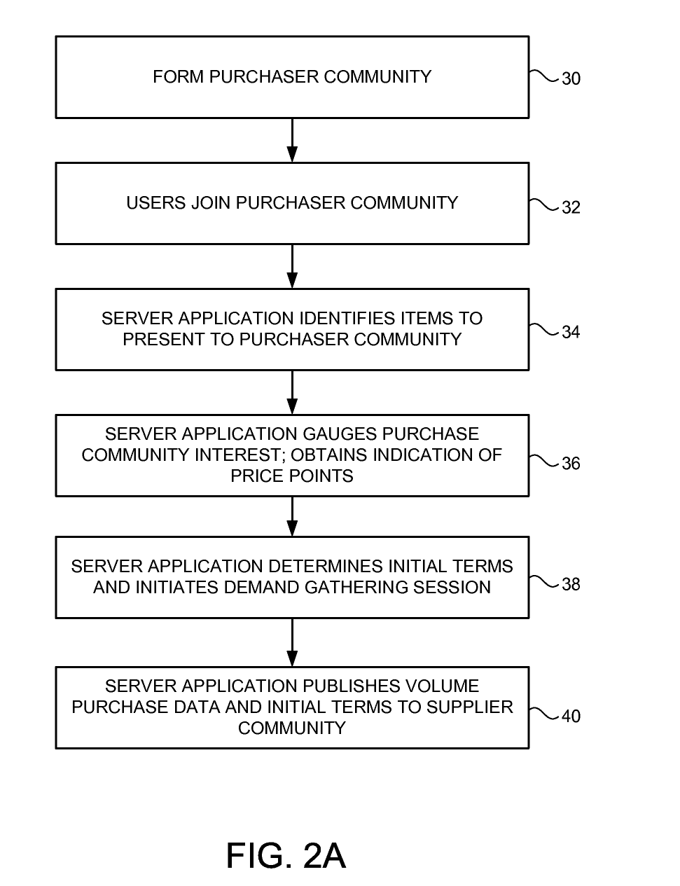

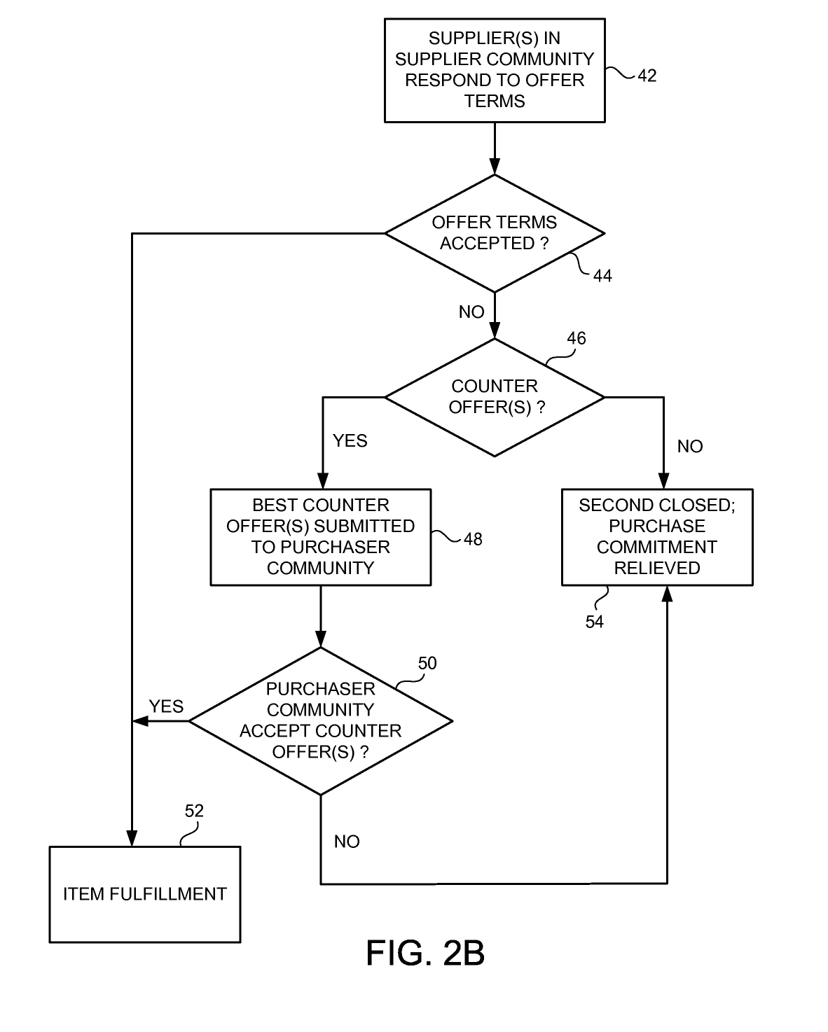

Turning to FIGS. 2A and 2B, a purchaser community is first created (30). The purchaser community may have a web presence, i.e., via a web site hosted on server 14, or may be implemented as part of a social networking site, such as facebook.com. The purchaser community may also exist as a text message or e-mail routing. Once implemented, an interested person (potential purchaser) may sign up to become a member of the purchaser community by way of a simple sign up process, or by way of paid subscription service (32).

The server application 16 identifies items to be presented to the purchaser community (34). The manner in which the server application may do so is described below. Once an item is presented to the purchaser community, the server application may initiate the interest session and present a series of questions or a questionnaire to the purchaser community directed to member interest in the item, amounts that members would be willing to pay for the item, and other purchase criteria (36). Based on the data collected during the interest session, the server application determines whether there is sufficient interest in the item to warrant proceeding further, and if so, determines the initial terms, i.e., an initial proposed purchase price for the item and other proposed purchase terms and conditions from the data gathered during the interest session, and the demand gathering session commences (38). During the demand gathering session, interested members of the purchaser community commit to purchase the item at the initial terms (i.e., make the purchase commitment), for example by supplying their credit card information and agreeing that their card will be charged at the initial proposed purchase price (or subsequently agreed to price, as explained below) if the server application consummates a volume purchase.

The demand gathering session remains open for a predetermined period of time (“incubation period”) so as to pool demand for the item. At the conclusion of the incubation period, members may no longer participate in the demand gathering session, or any of the subsequent events described below (voting, etc.) and the server application is thus equipped with the total volume of the item that the members have collectively agreed to purchase (“volume purchase data”) and the initial terms.

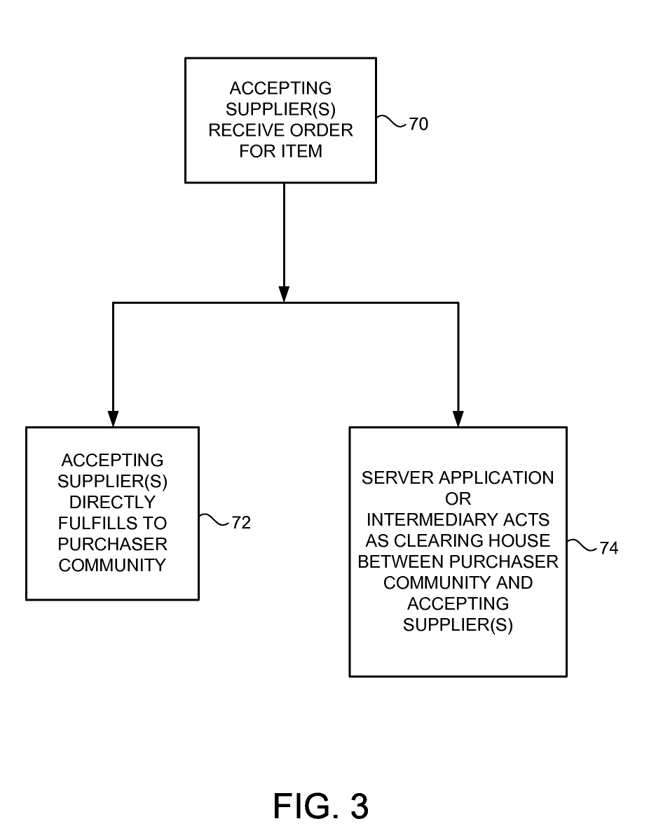

The server application next publishes the volume purchase data and initial terms to the supplier community 18 (40), and the various suppliers in the supplier community are given the opportunity to either accept the initial terms or to respond with counter-offer terms, such as a higher price (42, 44, 46). If no supplier accepts the initial terms, and one or more suppliers counter-offer, then the best counter-offer(s) are submitted to the purchaser community for consideration (48). The members of the purchaser community who committed to the initial terms offer (“original offerees”) may then decide whether to accept the counter-offer (50), for example by taking a vote of the original offerees. In one embodiment, if a super-majority, e.g., 60%, of the original offerees vote to accept a counter offer, then all original offerees are bound by the vote and to purchase the item on the new terms. At this juncture, the fulfillment process begins (52), as explained below and in connection with FIG. 3. If no supplier counter-offers, or if the original offerees reject the counter offer, then the session is closed and the members of the purchaser community are relieved of their purchase commitment (54).

By way of example, the server application 16 may have determined that a women's Riley Rose Fossil Watch, Gold Tone, Stainless Steel Bracelet is a hot or trending item, and may present the watch to the purchaser community to gauge its interest and determine the price that members of the purchaser community would be willing to pay to purchase this item. The server application may then initiate a demand gathering session whereby certain members commit to purchase the watch at a certain price and other terms (i.e., the initial terms), as determined by answers to questions posed to the purchase community by the server application. The server application may then present the initial terms to the supplier community. If a member of the supplier community accepts the initial terms, then all original offerees are committed to purchase the watch at the initial terms. If the initial terms are not accepted, but a member of the supplier community counter-offers with terms that are agreed upon by, e.g., a super-majority of the original offerees, then all original offerees are committed to purchase the watch at the terms of the counter-offer.

Exemplary purchase fulfillment methods are shown in FIG. 3. The supplier who accepted the initial terms, or who provided a winning counter-offer, fulfills purchase orders (“accepting supplier”). The server application may send the order directly to the accepting supplier (70), together with payment, and the accepting supplier may directly fulfill the order by shipping the items to the participating members of the purchaser community (72). The accepting supplier may also be responsible for handling all logistics, returns, chargebacks and the like directly with each participating member. Alternatively, the server application or an intermediary may act as a clearinghouse between the participating members of the purchaser community and the accepting suppliers (74).

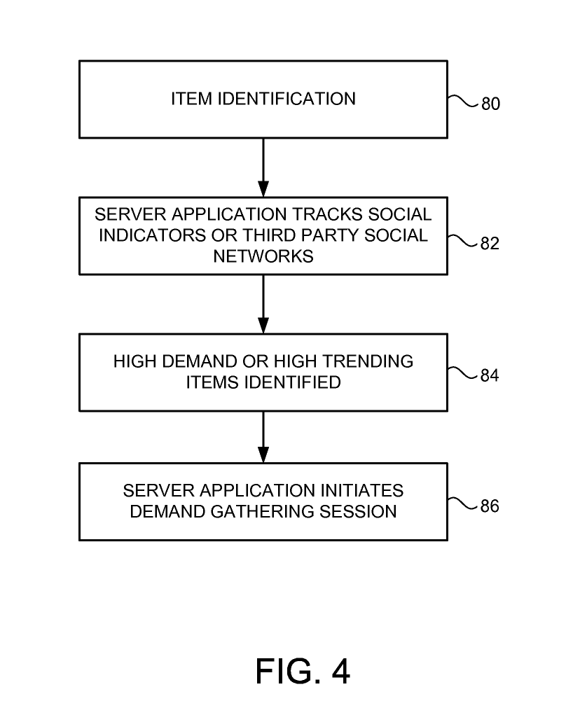

FIG. 4 illustrates an exemplary method (80) by which the server application may identify items to present to the purchaser community. The server application may track social indicators or sentiment to identify hot or trending items or activity or chatter on third party social networks, monitor activity in the reviews and comments of vendor web sites, and/or obtain information about such items via the purchaser community (82). Alternatively, high demand or high trending items may be identified by other means such as by research or surveys carried out by a party (including but not limited to the hosting entity), the results of which are supplied to the serverOnce a hot or trending item has been identified (84), it is presented to the purchaser community in an interest session (86).

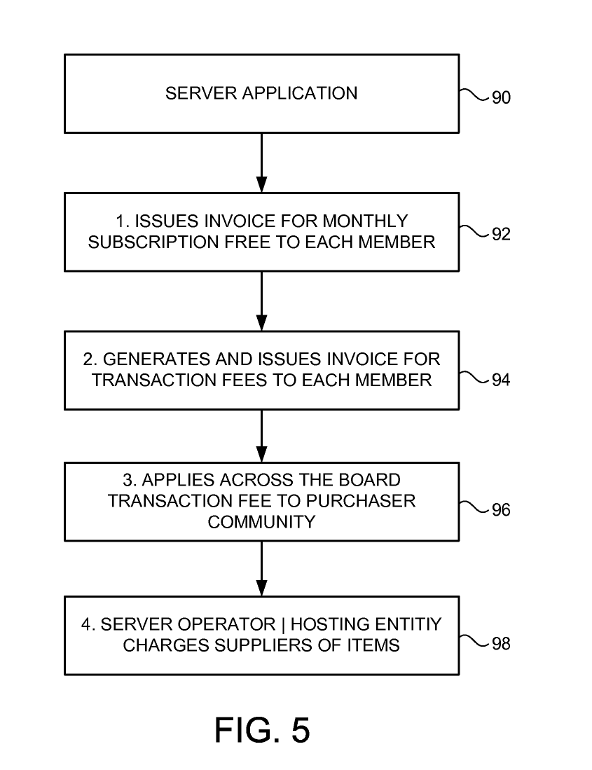

FIG. 5 illustrates a method (90) by which the operator of the server application may generate revenue. In one embodiment, members of the purchaser community may pay subscription fee and the server application may issue periodic (e.g., monthly) invoices for the fee (92). In another embodiment, the server application may apply a transaction fee to each member purchase (94). In yet another embodiment, the server application may apply across the board transaction fees to the purchaser community, which are to be allocated among and shared by the members (96). In still a further embodiment, the server operator and/or hosting entity may charge the suppliers of the items a fee or percentage of the sales price, and the like (98).

The foregoing method and system presents one preferred embodiment of the present invention. It should be appreciated that there are many alternative embodiments within the scope of the present invention. While the invention has been described, disclosed, illustrated and shown in various terms of certain embodiments or modifications, which it has presumed in practice, the scope of the invention is not intended to be, nor should it be deemed to be, limited thereby and such other modifications or embodiments as may be suggested by the teachings herein are particularly reserved, especially as they fall within the breadth and scope of the claims here appended.

1. A network based purchasing method comprising:
a. receiving, over a network and at a server, first information indicative of the identity of persons or entities desiring to become members of a an internet-based purchaser community, the server comprising a machine running a server application;
b. identifying an item for presenting to the purchaser community, and presenting, by the server, the item for consideration by the purchaser community;
c. receiving, over the network and at the server, from members of the purchaser community, second information indicative of a purchase interest by at least a plurality of the members, defining responding members, the second information including an indication of a price which each responding member is willing to commit for purchasing the item, and collecting by the server the second information from each responding member;
d. determining, by the server and based on the collected second information, proposed terms, including price, for purchasing the item and presenting, via by the server, the proposed terms to at least the responding members;
e. receiving, over the network and at the server, and for a selected period of time, defining an incubation period, third information indicative of commitments by a plurality of the responding members, defining committing members, to purchase the item at the proposed terms;
f. after the conclusion of the incubation period, presenting by the server, for consideration by members of a supplier community, an offer to purchase plural ones of the item at the proposed terms;
g. receiving, over the network and at the server, at least one of (i) an acceptance by a member of the supplier community to sell the plurality of items at the proposed terms or (ii) a counter-offer by a member of the supplier community to sell the plurality of items at alternative terms;
h. if no member of the supplier community accepts the proposed terms:
i. presenting, by the server, at least one of any counter-offer for consideration by the committing members;
ii. receiving, over the network and by the server, fourth information indicative of acceptances by committing members of any counter-offer;
iii. determining, by the server, whether to accept any counter-offer based on the fourth information;
i. via the server, initiating a fulfillment process for providing the item to each committing member at the proposed terms, if any supplier accepted the proposed terms, or, in the absence thereof, at any alternative terms accepted in (h)(iii).

2. The method of claim 1 wherein the server hosts a website and persons or entities desiring to become members of the purchaser community enroll via the website.

3. The method of claim 1 wherein the purchaser community is formed within a social networking website.

4. The method of claim 1 wherein members of the purchaser community communicate among themselves and with the server in the form of e-mail or text messaging.

5. The method of claim 1 wherein the item for presenting to the purchaser community is identified by the server.

6. The method of claim 1 wherein the item for presenting to the purchaser community is identified by one of tracking social indicators or sentiment within the purchaser community, tracking activity in social networks or by research or surveys.

7. The method of claim 1 wherein each committing member commits to purchasing the item at the terms agreed upon by the committing members collectively, by providing payment information such as credit card information.

8. The method of claim 1 wherein the server presents to the supplier community the number of items agreed to be purchased at the proposed terms.

9. The method of claim 1 wherein (h)(iii) comprises determining if a predetermined number of committing members have agreed to accept a counter-offer, and, if so, committing all of the committing members to purchase the item at the alternative terms.

10. The method of claim 1 wherein the server initiates the fulfillment process by informing a winning supplier, whereby the winning supplier initiates payment remittance and item fulfillment.

11. The method of claim 1 wherein the server or a hosting entity initiates the fulfillment process by serving as a clearinghouse for payment remittance or item fulfillment.

12. A non-transitory computer readable storage medium comprising executable instructions that when executed by an on-line server cause the server to:
a. receive, over a network, first information indicative of the identity of persons or entities desiring to become part members of a purchaser community;
b. present an item for consideration by the purchaser community;
c. receive, over the network, second information indicative of a purchase interest by least a plurality of members of the purchaser community, defining responding members, the second information including an indication of purchase terms,. including price, to which each responding member is willing to commit for purchasing the item, and collect the second information by the sever;
d. determine, based on the collected second information, proposed terms, including price, for purchasing the item and present the proposed terms to at least the responding members;
e. receive over the network for a selected period of time, defining an incubation period, third information indicative of commitments by a plurality of the responding members, defining committing members, to purchase the item at the proposed terms;
f. after the conclusion of the incubation period, present for consideration by members of a supplier community an offer to purchase plural ones of the item at the proposed terms;
g. receive over the network at least one of (i) an acceptance by a member of the supplier community to sell the plurality of items at the proposed terms or (ii) a counter-offer by a member of the supplier community to sell the plurality of items at alternative terms;
h. if no member of the supplier community accepts the proposed terms:
i. present at least one of any counter-offer for consideration by the committing members;
ii. receive over the network fourth information indicative of acceptances by committing members of any counter-offer;
iii. determine whether to accept any counter-offer based on the fourth information;
i. initiate a fulfillment process for providing the item to each committing member at the proposed terms, if any supplier accepted the proposed terms, or, in the absence thereof, at any alternative terms accepted in (h)(iii).

13. The non-transitory computer readable storage medium of claim 12 further comprising executable instructions that cause the server to host a website such that persons or entities desiring to become part members of the purchaser community may enroll via the website.

14. The non-transitory computer readable storage medium of claim 12 further comprising executable instructions that cause the server to identify the item to be presented to the purchaser community.

15. The non-transitory computer readable storage medium of claim 12 further comprising executable instructions that cause the server to receive payment information from the committing members.

16. The non-transitory computer readable storage medium of claim 12 further comprising executable instructions that cause the server to present to the supplier community the number of items agreed to be purchased at the proposed terms.

17. The non-transitory computer readable storage medium of claim 12 further comprising executable instructions that cause the server initiate the fulfillment process by informing a winning supplier, and inform the winning supplier to initiate a payment remittance and item fulfillment process.

18. The non-transitory computer readable storage medium of claim 12 further comprising executable instructions that cause the server to carry out step (h)(iii) by determining if a predetermined number of committing members have agreed to accept a counter-offer, and, if so, committing all of the committing members to purchase the item at the alternative terms.

19. The non-transitory computer readable storage medium of claim 12 further comprising executable instructions that cause the server or a hosting entity to initiate the fulfillment process by serving as a clearinghouse for payment remittance or item fulfillment.

20. A system for facilitating the purchase of an item comprising a server connected to the Internet, the server programmed to:
a. receive, over a network, first information indicative of the identity of persons or entities desiring to become members of a purchaser community;
b. present an item for consideration by the purchaser community;
c. receive, over the network, second information indicative of a purchase interest by least a plurality of members of the purchaser community, defining responding members, the second information including an indication of purchase terms to which each responding member is willing to commit for purchasing the item, and collect the second information at the sever;
d. determine, based on the collected second information, proposed terms for purchasing the item and present the proposed terms to at least the responding members;
e. receive over the network for a selected period of time, defining an incubation period, third information indicative of commitments by at least one of the responding members, defining committing members, to purchase the item at the proposed terms;
f. after the conclusion of the incubation period, present for consideration by members of a supplier community an offer to purchase plural ones of the item at the proposed terms;
g. receive over the network at least one of (i) an acceptance by a member of the supplier community to sell the plurality of items at the proposed terms or (ii) a counter-offer by a member of the supplier community to sell the plurality of items at alternative terms;
h. if no member of the supplier community accepts the proposed terms:
i. present at least one of any counter-offer for consideration by the committing members;
ii. receive over the network fourth information indicative of acceptances by committing members of any counter-offer;
iii. determine whether to accept any counter-offer based on the fourth information;
i. initiate a fulfillment process for providing the item to each committing member at the proposed terms, if any supplier accepted the proposed terms, or, in the absence thereof, at any alternative terms accepted in (h)(iii).

21. The system of claim 20 wherein the server is further programmed to host a website such that persons or entities desiring to become part of the purchaser community may enroll via the website.

22. The system of claim 20 wherein the server is further programmed to identify the item to be presented to the purchaser community.

23. The system of claim 20 wherein the server is further programmed to receive payment information from the committing members.

24. The system of claim 20 wherein the server is further programmed to present to the supplier community the number of items agreed to be purchased at the proposed terms.

25. The system of claim 20 wherein the server is further programmed to initiate the fulfillment process by informing a winning supplier, and inform the winning supplier to initiate a payment remittance and item fulfillment process.

26. The system of claim 20 wherein the server is further programmed to carry out step (h)(iii) by determining if a predetermined number of committing members have agreed to accept a counter-offer, and, if so, committing all of the committing members to purchase the item at the alternative terms.

27. The system of claim 20 wherein the server is further programmed to initiate the fulfillment process by serving as a clearinghouse for payment remittance or item fulfillment.
